(19) United States
(12) Patent Application Publication
(10) Pub. No.: US 2011/0225157 A1
(43) Pub. Date: Sep. 15, 2011

(54) METHOD AND SYSTEM FOR PROVIDING WEBSITE CONTENT

(76) Inventors: Shyam Sundar Rajaram, Mountain View, CA (US); Martin B. Scholz, San Francisco, CA (US); Filippo Balestrieri, Mountain View, CA (US)

(21) Appl. No.: 12/723,146

(22) Filed: Mar. 12, 2010

(51) Int. Cl. G06F 17/30; G06N 5/02

(52) U.S. Cl. 707/737; 707/E17.089; 707/E17.116; 707/769; 706/46

(57) ABSTRACT

An exemplary embodiment of the present invention provides a method of generating Website content. The method includes generating a client profile comprising a cluster type obtained from a list of cluster types and information received from a user ID, wherein the list of cluster types is generated by processing a database of computer usage. The method includes utilizing the relevant cluster types included in the client profile to a selected Website, wherein the cluster type is used by the Website at least in part to determine the content provided by the Website.

### BACKGROUND

Marketing on the World Wide Web (the Web) is a significant business. Users often purchase products through a company's Website. Further, advertising revenue can be generated in the form of payments to the host or owner of a Website when users click on advertisements that appear on the Website. The amount of revenue earned through Website advertising and product sales may depend on a Website's ability to attract clients and develop a loyal base of returning clients. Often, the ability to attract a client to a particular Website depends on the organization of the Website and whether the user is able to effectively navigate the Website to locate relevant information or products.

### BRIEF DESCRIPTION OF THE DRAWINGS

Certain exemplary embodiments are described in the following detailed description and in reference to the drawings, in which:

FIG. 1 is a block diagram of a computer network in which a client computer system can access a search engine and Websites over the Internet, in accordance with exemplary embodiments of the present invention;

FIG. 2 is a process flow diagram showing a first part of the method of personalizing a Website, in accordance with exemplary embodiments of the present invention;

FIG. 3 is a diagram showing the correlation between cluster types and computer usage segments, in accordance with exemplary embodiments of the present invention;

FIG. 4 is a decision flow diagram showing a method for determining cluster information to identify relevant computer usage segments, in accordance with exemplary embodiments of the present invention;

FIG. 5 is a process flow diagram showing a second part of the method of personalizing a Website, in accordance with exemplary embodiments of the preset invention; and

FIG. 6 is a block diagram showing a non-transitory, computer readable medium that stores code adapted to facilitate the personalization of Website content, in accordance with an exemplary embodiment of the present invention.

### DETAILED DESCRIPTION OF SPECIFIC EMBODIMENTS

Exemplary embodiments of the present invention provide techniques for delivering personalized Web page content that more closely represents the interests of a client to a Web page. As used herein, the term “exemplary” merely denotes an example that may be useful for clarification of the present invention. The examples are not intended to limit the scope, as other techniques may be used while remaining within the scope of the present claims. The techniques disclose herein can improve a Website experience by personalizing the appearance and content of the Website, which may lead to increased traffic and, thus, revenue for the Website. This personalizing of the Website may be particularly important when the Website first encounters a particular client identifier (user ID) for which prior Website use information is not available.

A user ID is a unique identifier used to identify a particular system used to access a Website, for example, an IP address, a client name, and the like. In the exemplary embodiments of the present invention, a relatively small number of questions are presented in a sequence to the user ID and the answers received associated with those questions are utilized to personalize the Website. The answer that is received to a question may be utilized to determine the next question that is presented to the user ID based on a decision tree. In this manner, the next question asked depends on the answers to all the previous questions. Based on an analysis of the received answers, specific Website content may be selected to be presented to the user ID.

A first task in accordance with embodiments of the present invention is to categorize possible Website clients, as represented by a user ID, into use segments. This may be achieved by identifying and statistically processing a source of information on computer usage by consumers to identify clusters as described below. One source of such computer usage may be a computer usage survey such as may be provided by FORRESTER RESEARCH, INC. (400 Technology Square, Cambridge, Ma 02139). However other survey suppliers may provide computer usage information surveys also. These surveys may typically include a hundred or more multiple yes/no questions answered by thousands of people related to activities performed on a home or other computer by those surveyed.

In an exemplary embodiment of the present invention, the identified computer usage information is statically processed and cluster information is generated and used to provide a cluster type or a vocabulary of possible client interests for a user ID that is used to access one or more Websites. The resulting cluster information may provide groupings of words that pertain to the content of Websites. The groupings, referred to herein as “clusters,” may be used to characterize the content of individual Websites in terms of the interests of clients that visit those Websites. Each cluster can represent a unique cluster type and may be assigned a unique cluster-type descriptor. The resulting cluster information can provide words that pertain to the usage of Websites the surveyed computer clients reported that they made of visited Websites.

A use-case refers to a particular market or markets a Website content is useful to address. As used herein, a Website may include one or more Web pages each of which may have, or may be configured to have different content. In addition, each Web page may also have sub Web pages.

Usage segment types corresponding to the interests of a particular client are determined initially by answers to questions provided by that client's user ID. These answers are utilized, upon accessing a selected Website, to make an initial determination of which usage segments and cluster types relate to content available from the selected Website. The Website may use the cluster types to customize the Website according to the interests indicated by the answers provided from the user ID. This is useful when a user ID is received for the first time by a Website and information relating to prior computer usage associated with that user ID may not be available to the Website.

An exemplary embodiment of the present invention enables a Website to provide relevant client interest information to a first time client while reducing the likelihood that extraneous or irrelevant information will be presented to the client. This may provide the Website client with a more favorable initial impression of the Website when prior information of the client's interest is not available to the Website.

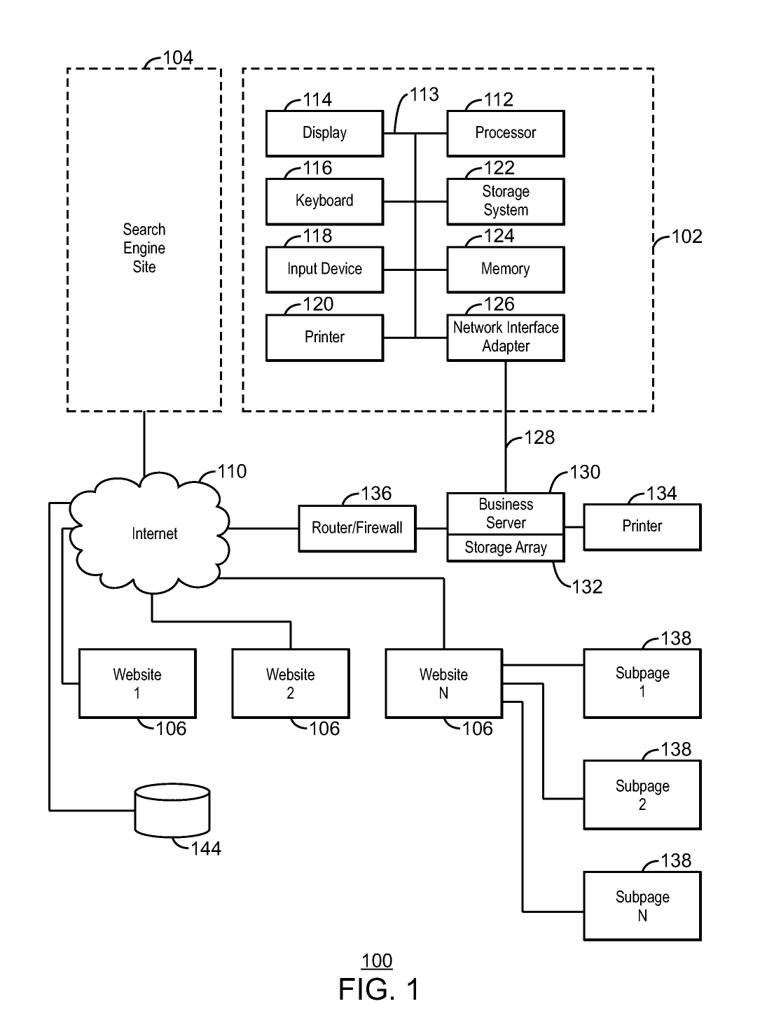

FIG. 1 is a block diagram of a computer network 100 in which a client system 102 can access a search engine 104 and Websites 106 over the Internet 110, in accordance with exemplary embodiments of the present invention. Although the Websites 106 are actually virtual constructs that are hosted by Web servers (not shown), they are described herein as individual (physical) entities, as multiple Websites 106 may be hosted by a single Web server and each Website 106 may collect or provide information about particular user IDs. Further, each Website 106 will generally have a separate identification, such as a URL, and function as an individual entity. As illustrated in FIG. 1, the client system 102 will generally have a processor 112 which may be connected through a bus 113 to a display 114, a keyboard 116, and one or more input devices 118, such as a mouse or touch screen. The client system 102 can also have an output device, such as a printer 120 connected to the bus 113.

The client system 102 can have other units operatively coupled to the processor 112 through the bus 113. These units can include tangible, machine-readable storage media, such as a storage system 122 for the long term storage of operating programs and data, including the programs and data used in exemplary embodiments of the present techniques. The storage system 122 may also store a database of cluster information and a client profile generated in accordance with exemplary embodiments of the present techniques. Further, the client system 102 can have one or more other types of non-transitory, computer readable storage media, such as a memory 124, for example, which may comprise read-only memory (ROM) and/or random access memory (RAM). In an exemplary embodiment, the client system 102 includes a network interface adapter 126, for connecting the client system 102 to a network, such as a local area network (LAN 128), a wide-area network (WAN), or another network configuration. The LAN 128 can include routers, switches, modems, or any other kind of interface device used for interconnection.

Through the LAN 128, the client system 102 can connect to a business server 130. The business server 130 can have a storage array 132 for storing enterprise data, buffering communications, and storing operating programs for the business server 130. The business server 130 can have associated printers 134, scanners, copiers and the like. The business server 130 can access the Internet 110 through a connected router/firewall 136, providing the client system 102 with Internet access. Those of ordinary skill in the art will appreciate that business networks can be far more complex and can include numerous business servers 130, printers 134, routers 136, and client systems 102, among other units. Moreover, the business network discussed above should not be considered limiting as any number of other configurations may be used. For example, in embodiments, the client system 102 may be directly connected to the Internet 110 through the network interface adapter 126, or may be connected through a router or firewall 136. Any system that allows the client system 102 to access the Internet 110 should be considered to be within the scope of the present techniques.

Through the router/firewall 136, the client system 102 can access a search engine 104 connected to the Internet 110. In exemplary embodiments of the present invention, the search engine 104 can include generic search engines, such as GOOGLE™, YAHOO®, BING™, and the like. The client system 102 can also access the Websites 106 through the Internet 110. The Websites 106 can have single Web pages, or can have multiple sub pages 138. The Websites 106 can also provide search functions, for example, searching sub pages 138 to locate products or publications provided by the Website 106. For example, the Websites 106 may include sites such as EBAY®, AMAZON.COM™, WIKIPEDIA™, CRAIGSLIST™, FOXNEWS.COM™, and the like. Further, one or more of the Websites 106 may be configured to receive information from a client to the Website, for example, from a unit located at a particular user ID, regarding interests of the client, and the Website may use the information to determine, in part, the content to deliver to the user ID.

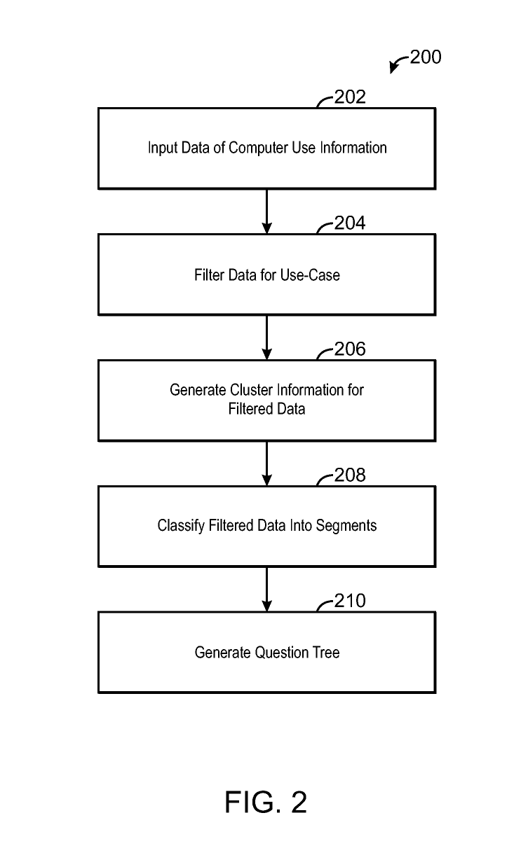

One or more Websites 106 may also access a database 144, which is connected to the Internet 110 and includes computer usage information from, for example, a survey of computer usage. The database 144 may also include cluster information, which may be generated, at least in part, by an automated or other analysis of the computer usage information as described below in reference to FIG. 2. The cluster information may be used, along with answers provided from a user ID, to communicate a client's interests to a selected Website, as discussed with respect to FIGS. 2-5.

FIG. 2 is a process flow diagram showing a first part of a method of personalizing a Website, in accordance with exemplary embodiments of the present invention. Referring to FIG. 2 and also FIG. 1, the method 200 may be executed on a Website 106. However, in embodiments, all or part of the method 200 may be executed on other devices, such as the search engine 104, or an individual Website Sub page 138. Also while Blocks 202-210 are depicted in sequential order, this is for ease of description and not a limitation in the order of which the method 200 is implemented.

The method begins at block 202, wherein a source of information on consumer computer usage may be filtered 204. The output of the filtering process 204 is a list of yes/no questions relevant to a particular use-case of activities performed on a home or other computer. Such activities include internet usage, social activities, audio and video usage, gaming participation, online shopping and other activities. These questions represent a multidimensional binary vector that can be used to classify each particular surveyed client where a value of 1 may be used to correspond to answering yes to a question. If, for example, there were 5000 computer clients surveyed and 150 questions were selected, then the computer usage of each of the 5000 surveyed clients may be represented by 150 binary vectors based on their answers to the 150 selected survey questions. In some embodiments, the answers may be in the form of preferences such as, for example, a rating of 1 to 5 instead of in binary form. The questions are selected to be relevant to a target market, or use-case, of a particular Website which may be utilized by a user ID. This selection of relevant questions may be made from a list that may include more than a hundred questions some of which may not be relevant to a use-case of interest. Therefore the non relevant questions may be discarded or not further utilized. The selection of relevant questions may be performed by automated or manual means.

At block 206, cluster information is generated from the selected questions. The cluster information may be generated by automated analysis of the questions by, for example, a statistical analysis such as clustering, co-clustering, information-theoretic co-clustering, and the like based on a specific use-case. In one exemplary embodiment of the present invention, the automated analysis includes segmenting the questions into cluster types. In an implementation where the set of selected questions is sufficiently small, the cluster information may be generated manually based on a specific use-case. As used herein, the term “cluster type(s)” refers to a unique cluster that represents a particular client's interest or type of Web content. Each cluster may also be assigned a unique cluster-type descriptor, as will be explained further below. For example, questions relating to photography can be assigned to cluster type “Q” where Q is a unique cluster identification reference. In like manner questions relating to stocks can be assigned to cluster type G. It should also be noted that a cluster may be a single question such as “do you purchase airline tickets?” Therefore a cluster may also be considered a category or usage type. Exemplary individual clusters types that may be identified by a cluster analysis are detailed in Table 1. Of course the use of different computer usage information or other analytical tools may generate the same, less, more or different clusters types.

TABLE 1
Cluster Types

| | |
|---|---|
| A | Word Processing |
| B | Music Related |
| C | Play Free Computer Games |
| D | Watch YOUTUBE |
| E | Burn CD/DVDs |
| F | Never Bought Products Online |
| G | Buy Stocks & Mutual Funds |
| H | Backup Files |
| I | Instant Messaging |
| J | Visit Social Networking |
| K | Video Editing |
| L | Use Presentation Software |
| M | Buy Airline Tickets |
| N | Purchase Games |
| O | Use Educational Software |
| P | Manage Personal Finances/Taxes |
| Q | Photo Related |

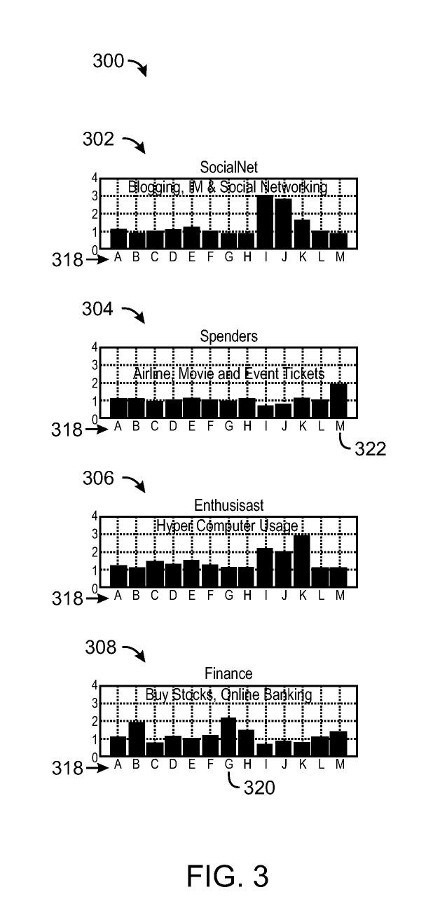

At block 208 by using topic modeling analysis such as, for example, Probabilistic Latent Semantic Indexing (“PLSI”) analysis or Latent Dirichlet Allocation (“LDA”), on the identified binary vectors, computer usage segments are identified. In the exemplary example, four usage segments were identified: Social Net Usage, Spenders, Enthusiast, & Finance. The segment names such as “Spenders” are arbitrary, but are selected to aid human understanding of aspects of the related segment. For example, the “Spenders” segment can represent computer purchasing usage such as the purchase of airline, movie and other event tickets. The relationship between the Clusters and the usage Segments is illustrated in FIG. 3 which is described below. It should be noted that PLSI and LDA are soft clustering algorithms and that the Segments are also clusters. In the interests of clarity, the usage segment clusters will be referred to as “Segments” in the descriptive specification herein.

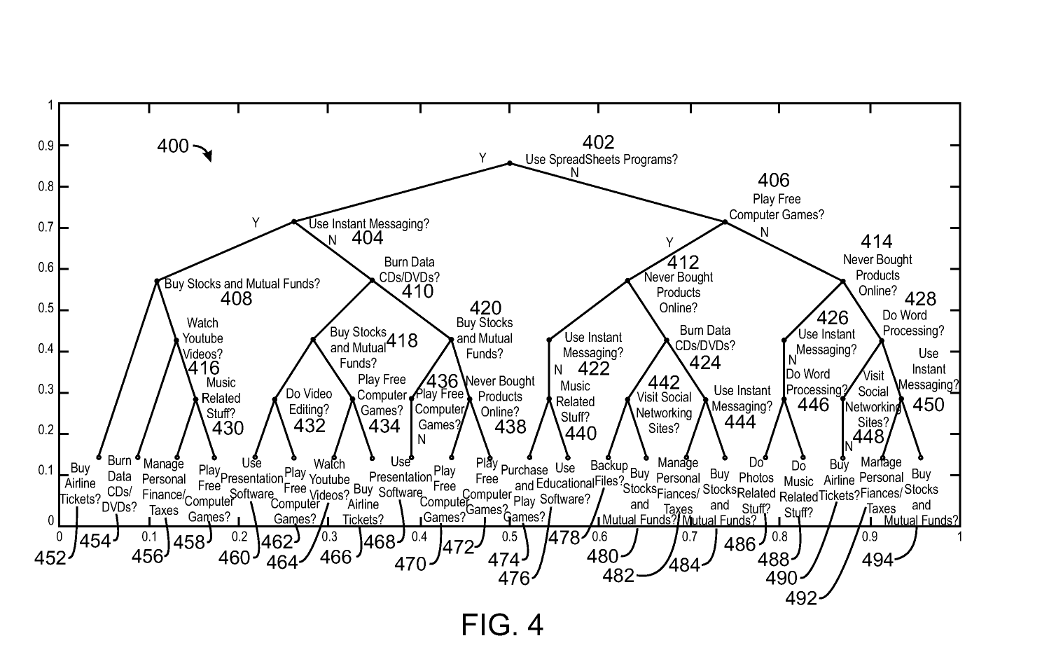

At Block 210 a decision tree is generated from the cluster data from 206. An example of a decision tree is graphically illustrated in FIG. 4, which is described below. The decision tree is computed using the C4.5 Decision-tree Induction Algorithm. The C4.5 algorithm was authored in 1993 by J. R. Quinlan, Programs for Machine Learning, published by Morgan Kaufmann Publishers, now Harcourt General, Inc, 27 Boylston Street, Chestnut Hill, Mass. This algorithm builds the tree top-down and picks the split at each node that maximizes the information gain. The information gain is based on the class of the minimal number of questions that can be asked sequentially the answers of which can be used to reliably place a client, as represented by a user ID, to a Website in one or more relevant Segments.

The maximum depth of the resultant tree is limited to about 6 levels in the exemplary embodiment discussed herein, but in some applications a deeper tree may be useful. However, a tree of level 6 will provide a set of questions that may generally provide an adequate level of information from a first time Website client, as represented by a user ID, without the number of questions becoming objectionable. While a more accurate categorization of a first time client may be had by asking 150 questions, most Website clients would find having to answer so many questions undesirable and refuse to use the associated Website. The answers from an user ID to these questions can be subsequently utilized to determine the content of a displayed Website. Once the decision tree is generated, it may remain fixed for a particular use-case and utilized to classify any user ID that is presented to the Website for the first time.

FIG. 3 illustrates four lift charts for the four Segments depicting the graphical representation of the relationship between computer usage Segments 302-308 and thirteen 318 of the cluster types from Table 1 above. Each of the cluster types 318 has associated with it a value representing the degree of correlation between the particular cluster type 318 and a particular usage Segment 302-308. For example, in the Finance usage segment 308, the cluster type G, 320, which represents stock purchases, shows a high correlation with this usage Segment. Additionally, in the Spenders usage segment 304, cluster type M, 322, which represents buying tickets, shows a high correlation to this usage Segment. Lift charts generally illustrate a measure of the effectiveness of a predictive model calculated as the ratio between the results obtained with and without the predictive model and are well known in the art. The greater the lift, or height of the bar on the chart, the better the model.

FIG. 4 illustrates an exemplary six level decision tree 400 generated as previously described in association with block 210 of FIG. 2. This tree details the questions 402-494 and the sequence of those questions 402-494 that are presented to a user ID on the first visit of that user ID to the Website. Each of the questions 402-494 relate to a particular cluster type A-Q listed in Table 1 and illustrated in FIG. 3. For example, the questions relating to instant messaging 404, 422, 426, 444 and 450 relate to cluster type “I” “Instant Messaging.” As an additional example, questions relating to buying stocks and mutual funds 408, 418,420, 480, 484 and 494 relate to cluster type “G” “Buy Stocks & Mutual Funds.” In some cases fewer than 6 responses are needed from a user ID to initially assign the user ID to a usage segment 302-316. For example, question 436 “play free computer games”, can elicit either a “yes” or a “no” response from the user ID. A “yes” response to question 436 terminates the decision tree at level 5 of the decision tree 400.

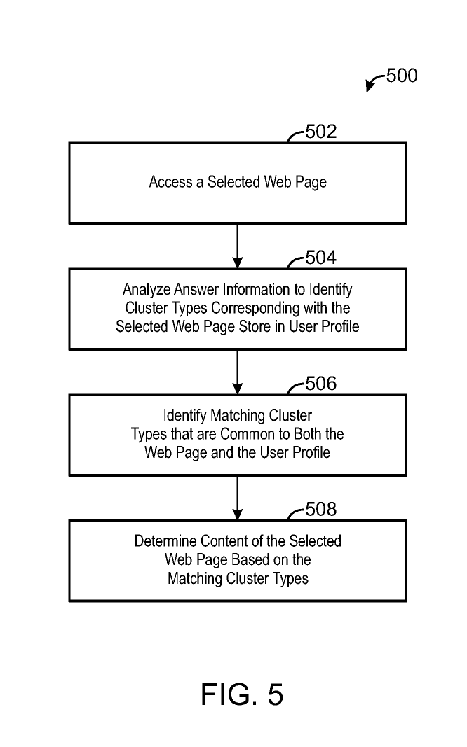

FIG. 5 is a process flow diagram 500 showing a process to customize a Website in response to information received from a user ID, in accordance with exemplary embodiments of the present invention. The process shown in FIG. 5 may be executed by a server hosting a Website 106 (FIG. 1), by the processor 112 of the client system, or by the business server 134. At block 502, a user ID is received by the Website and is evaluated to determine if this is a case of first instance. That is, has this user ID accessed this Website before. If the user ID has not accessed the Website before, then information about the interests or purchasing history associated with the user ID may not be available to the Website. Therefore information useful to customize the Website or Website sub pages may not be available. In this case, the decision tree, as described in association with FIG. 4, is utilized to generate questions that are sent to the user ID.

At block 504, Using the decision tree of FIG. 4, the first question 402 sent to the user ID is “do you use spreadsheets?” If the response received from the user ID is “yes”, then the next question sent to the user ID would be 404 “do you use instant messaging?” If the answer to question 402 is “no”, the next question sent to the user ID would be 406 “do you play free computer games?” In this exemplary decision tree, an affirmative answer identifies the next question to be located at the next lower level of the tree and on the left branch. A negative answer identifies the next question to be located at the next lower level of the tree and on the right branch. This question and answer process continues until six levels of the tree has been traversed and the last question is one of questions 452-494, or the tree terminates at an earlier level such as at question 436 upon receipt of an affirmative answer to question 436. As discussed before, each question relates to a specific cluster type or Segment. For example, question 404 is associated with cluster type “I” in Table 1. After the decision tree has been followed down to level 6 or an earlier termination point, all of the affirmative answers indicate one or more computer usage Segments 302-308 of interest to that user ID from which the specific cluster types A-Q that may be relevant are determined. For example, if the usage Segment 302 is indicated, then content associated with clusters I and J may be of interest to the user ID. Also determined are cluster types A-Q that may not be of interest to that user ID.

Once a usage Segment 302-308 is identified, then content likely relevant to that usage Segment may be selected and displayed or made available to the User-ID by a Website. This may provide a first time client to the Website, as represented by a user ID, a more satisfying experience. In other embodiments, once a specific cluster type A-Q is determined to be relevant to the user ID as indicated by the received answers, the content of the Website may be customized to present or otherwise make available to the user ID content without relying on or determining one or more relevant usage Segments 302-308.

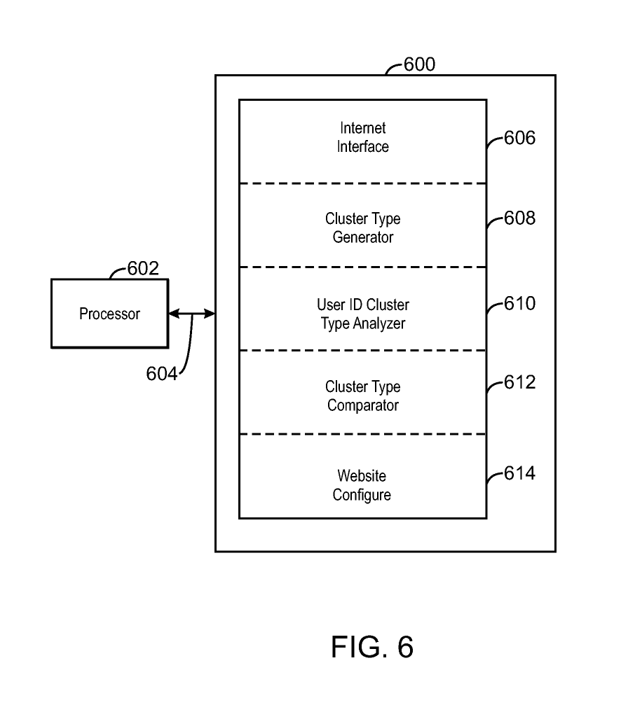

FIG. 6 is a block diagram showing a non-transitory, computer readable medium that stores code adapted to facilitate the personalization of Website content, in accordance with an exemplary embodiment of the present invention. The non-transitory, computer readable medium is generally referred to by the reference number 600. The non-transitory, computer readable medium 600 can comprise RAM, a hard disk drive, an array of hard disk drives, an optical drive, an array of optical drives, a non-volatile memory, a USB drive, a DVD, a CD or the like. In one exemplary embodiment of the present invention, the non-transitory, computer readable medium 600 can be accessed by a processor 602 over a computer bus 604.

The various software components discussed herein can be stored on the non-transitory, computer readable medium 600 as indicated in FIG. 6. For example, a first block 606 on the non-transitory, computer readable medium 600 may store an Internet interface to receive user ID accesses to a selected Web site or Web page. A second block 608 can include a cluster type generator configured to add cluster types to a list of cluster types. A third block 610 can include a user ID cluster type analyzer to determine cluster types associated with the user ID based on information received from the user ID through the internet interface 606.

A forth block 612 can include a cluster type comparator for analyzing information received from a user ID to identify one or more matching computer usage Segments associate with the Website. A fifth block 614 can include a Website or Web page configurator to customize a Web page or a Website to display information related to the matching computer usage Segmentss.

Although shown as contiguous blocks, the software components can be stored in any order or configuration. For example, if the non-transitory, computer readable medium 600 is a hard drive, the software components can be stored in non-contiguous, or even overlapping, sectors.

What is claimed is:

1. A method of generating Website content, comprising:
generating a client profile comprising a cluster type obtained from a list of cluster types and selected at least in part by information received by the Website, wherein the list of cluster types is generated by processing a database of computer usage; and
wherein the cluster type is used by the Website, at least in part, to determine content provided by the Website.

2. The method of claim 1, further comprising determining a matching cluster type, the matching cluster type being a cluster type that is common to both the client profile and the selected Website.

3. The method of claim 1, wherein each of the cluster types in the list of cluster types corresponds to a list of computer use segments that correlate to content available on the Website.

4. The method of claim 1, wherein generating the client profile comprises receiving information from a user ID and identifying a cluster type associated with the information.

5. The method of claim 4, wherein identifying the cluster type comprises:
sending a query to the user ID and utilizing information received based on the query to identify a computer use segment.

6. The method of claim 5, wherein sending the query comprises:
utilizing a decision tree of questions to determine a query to send to the user ID.

7. The method of claim 5, wherein generating the client profile comprises:
sending multiple queries to the user ID and utilizing information received based on the queries to identify multiple cluster types which are added to the client profile.

8. The method of claim 5, wherein the use segment is analyzed by the Website and is utilized in part to determine the content provided by the Website.

9. A computer system, comprising:
a processor that is adapted to execute machine-readable instructions;
a storage device that is adapted to store data, the data comprising a client profile that includes a cluster type obtained from a list of cluster types and selected at least in part by information received by the computer system, wherein the list of cluster types is generated by processing a database of computer usage; and
a memory device that stores instructions that are executable by the processor, the instructions comprising:
an Internet interface configured to receive accesses over a network interface from a user ID and to send Website content corresponding to the cluster type to the user ID through the internet interface;
a profile generator that adds the cluster type to the client profile based on information received from the user ID in response to queries sent by the computer system to the user ID; and wherein the Website content is determined at least in part by the cluster type.

10. The computer system of claim 9, wherein the profile generator is configured to add more than one cluster type to the client profile based at least in part on the information received from the user ID.

11. The computer system of claim 9, wherein the list of cluster types is determined via at least one of clustering, co-clustering, or information-theoretic co-clustering.

12. The computer system of claim 9, wherein a usage segment is determined in part from the information received from the user ID and a cluster type associated with the usage segment is added to the client profile.

13. The computer system of claim 9, wherein the profile generator generates multiple queries that are sent to the user ID and the profile generator utilizes information received from the queries to add clusters to the client profile.

14. The computer system of claim 13, wherein the profile generator utilizes a decision tree of questions to determine a query to send to the user ID.

15. The computer system of claim 14, wherein the computer system sends multiple queries to the user ID and utilizes information received based on the queries to identify multiple cluster types to add to the client profile.

16. A non-transitory, computer readable medium, comprising code configured to direct a processor to:
receive an access to a selected Web page from a user ID;
analyze information received from the user ID to identify a first list of cluster types corresponding with the user ID;
analyze a list of clusters to identify a second list of cluster types corresponding with the selected Website
analyze a client profile comprising the first list of cluster types to identify a matching cluster type that is common to both the first list and the second list; and
utilizing the matching cluster type in part to determine the content provided by the Website.

17. The non-transitory, computer readable medium of claim 16, comprising code configured to direct the processor to correlate the matching cluster type usage segments.

18. The non-transitory, computer readable medium of claim 17, comprising code configured to direct the processor to utilize a high correlated usage segment to determine the Website content.

19. The non-transitory, computer readable medium of claim 16, comprising code configured to direct the processor to send multiple queries to the user ID wherein the queries are based on a decision tree of questions.

20. The non-transitory, computer readable medium of claim 19, comprising code configured to direct the processor to receive information from the user ID in part in response to the multiple queries and to utilize the received information to determine a usage segment and a corresponding list of cluster types.
